(19) United States
(12) Patent Application Publication
(10) Pub. No.: US 2003/0202840 A1
(43) Pub. Date: Oct. 30, 2003

(54) Adjustable pivot joint

(76) Inventor: Mervyn M. Watkins, Rancho Palos Verdes, CA (US)

Correspondence Address: Attn: Spyros J. Lazaris, Esq., OPPENHEIMER WOLFF & DONNELLY LLP, Suite 3800, 2029 Century Park East, Los Angeles, CA, 90067, US

(21) Appl. No.: 10/136,753

(22) Filed: Apr. 30, 2002

(51) Int. Cl. F16D 1/12

(52) U.S. Cl. 403/97

(57) ABSTRACT

Systems and techniques are disclosed for providing an adjustable pivot joint apparatus. The apparatus includes a plate system having interlocking clutch plates which, when separated, allow the apparatus to pivot about an axis. The interlocking clutch plates prevent the apparatus from pivoting about the axis when in a locked position. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND OF THE INVENTION

1. Field of the Invention

The present invention relates to a joint mechanism. More specifically, the present invention relates to an adjustable pivot joint apparatus having a releasable locking structure.

2. General Background and State of the Art

There are many examples of pivot joints in the marketplace today. Most existing products include two halves fastened together which pivot about a particular point. Some of these products include a locking mechanism which, when released, allows the pivot joint to move about a particular point. However, many pivot joints fail over time due to frequent twisting between the two half joints. Other pivot joints are heavy and expensive to manufacture.

### INVENTION SUMMARY

In one aspect of the present invention, a pivot joint includes a plate system having a first pair of joint plates, a first clutch plate, a second pair of joint plates, and a second clutch plate, the first and second clutch plates each having a grooved portion such that the first and second clutch plates are interlockable by engaging the grooved portions in each of the first and second clutch plates. The pivot joint also includes a spring mechanism positioned between the second clutch plate and one joint plate in the second pair of joint plates, and a pivot piece about which at least one joint plate in the first pair of joint plates and the first clutch plate are rotatable.

In another aspect of the present invention, a pivot joint includes a plate mechanism having a first clutch plate and a second clutch plate capable of lockably engaging, each of the first and second clutch plates having an elevated portion with a plurality of grooves and a plurality of bars therein such that when the elevated portions of each of the first and second clutch plates are aligned together, the plurality of bars of one of the first and second clutch plates lockably engage with the plurality of grooves of the other of the first and second clutch plate. The pivot joint also includes a release mechanism having a series of pins configured to disengage the first clutch plate from the second clutch plate when the series of pins pushes the second clutch plate against a spring mechanism.

In yet another aspect of the present invention, a method of pivoting a joint apparatus includes providing a plate system including a first pair of joint plates, a first clutch plate, a second pair of joint plates, and a second clutch plate, the first and second clutch plates each having grooved portions such that the first and second clutch plates are securable by interlocking the grooved portions in each of the first and second clutch plates. The method also includes releasing the first and second clutch plates by activating a series of pins to push the second clutch plate against a spring mechanism, rotating at least one joint plate in the first pair of joint plates around a pivot piece, and locking the first and second clutch plates in a desired position by deactivating the series of pins to release pressure on the spring mechanism and engage the grooved portions on the first and second clutch plates to prevent the first and second clutch plates from moving relative to each other.

In still another aspect of the present invention, a method of pivoting a joint apparatus including providing a plate system having a pair of clutch plates each having grooved portions that allow the pair of clutch plates to interlock when interlocked together, releasing the pair clutch plates by activating a release mechanism to force the pair of clutch plates apart, rotating a first clutch plate in the pair of clutch plates about a pivot piece, and locking the pair of clutch plates in a desired position by deactivating the release mechanism allowing the grooved portions on the pair of clutch plates to engage each other and prevent the pair of clutch plates from moving relative to each other.

It is understood that other embodiments of the present invention will become readily apparent to those skilled in the art from the following detailed description, wherein it is shown and described only exemplary embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings wherein:

FIG. 1 is a cross-sectional view of a pivot joint apparatus according to the present invention;

FIG. 2 is a perspective view of particular plate components of the pivot joint apparatus of the present invention;

FIG. 3 is a perspective view of the pivot joint apparatus of the present invention;

FIG. 4 is a side view of the pivot joint apparatus of the present invention; and

FIG. 5 is another side view of the pivot joint apparatus of the present invention.

### DETAILED DESCRIPTION OF THE EMBODIMENTS

The detailed description set forth below in connection with the appended drawings is intended as a description of exemplary embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

In an exemplary embodiment of the present invention, an adjustable pivot joint apparatus is provided having a plate system which includes interlocking clutch plates which, when separated, allow the apparatus to pivot about an axis. The apparatus also includes a release mechanism and a spring mechanism. The clutch plates prevent the apparatus from pivoting about the axis when in a locked position.

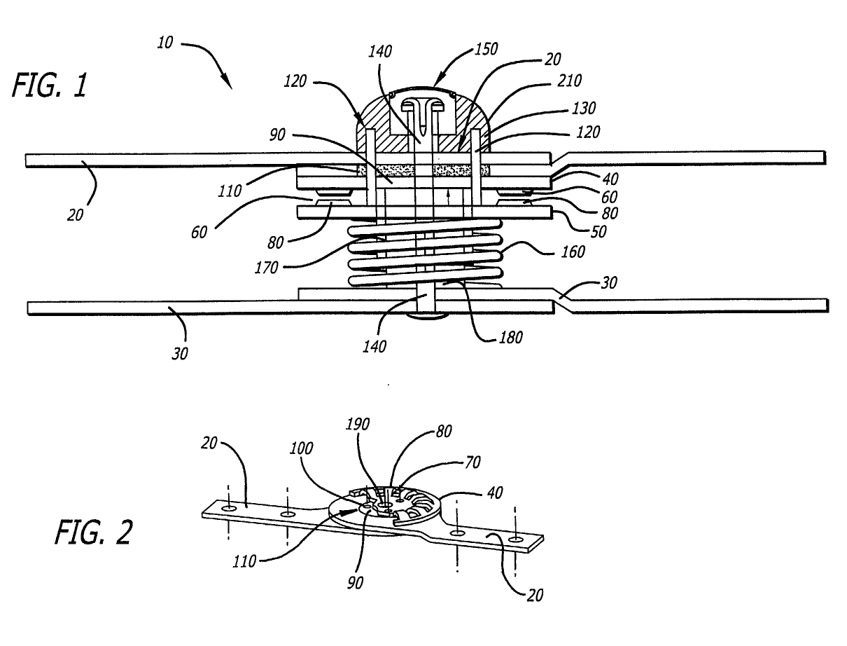

FIG. 1 is a cross-sectional view of a pivot joint apparatus 10 according to the present invention. The pivot joint apparatus 10 of FIG. 1 is shown in an unlocked position. The pivot joint apparatus 10 includes a system of plates. The system of plates includes a first pair of joint plates 20 and a second pair of joint plates 30. The system of plates also includes a first clutch plate 40 and a second clutch plate 50. The first clutch plate 40 may be coupled to the first pair of joint plates 20. The first and second clutch plates 40 and 50 may be substantially circular in shape. The first and second clutch plates 40 and 50 may be made of sheet metal or any other material of suitable strength.

In one embodiment, each of the first and second clutch plates 40 and 50 may include an elevated portion 60. The elevated portion 60 includes a series of grooves 70 and bars 80 between the series of grooves 70. Each of the first and second clutch plates 40 and 50 also include a central portion 90 which may have a series of holes 100 positioned therein.

The first and second clutch plates 40 and 50 may be positioned such that the elevated portions 60 face each other. The bars 80 in the elevated portion 60 of one clutch plate fit into the series of grooves 70 of the elevated portion 60 of the other clutch w plate. When the elevated portions 60 fit together, this results in the first and second clutch plates 40 and 50 being in an interlocked, secure position relative to each other, such that neither of the first or second clutch plates 40 and 50 can move laterally until the bars 80 are disengaged from the series of grooves 70.

The first and second clutch plates 40 and 50 may include any number of grooves 70 and bars 80 in their elevated portions 60. Additionally, the grooves 70 and bars 80 may be flat with respect to the other components of the first and second clutch plates 40 and 50, or may be depressed within the first and second clutch plates 40 and 50. Other embodiments for interlocking the first and second clutch plates are also contemplated in the present invention. For example, a gear system may be used to interlock the first and second clutch plates to prevent their movement relative to each other. It is noted that any means of providing interlocking mechanical components can be used with the present invention to achieve a locking system that prevents one or more components from moving.

The pivot joint apparatus 10 also includes a pivot piece 110 positioned in one of the joint plates in the first pair of joint plates 20. The pivot joint apparatus 10 also includes a release mechanism. In one embodiment, the release mechanism has a series of pins 120 housed in a head portion 130. The series of pins 120 penetrate the first pair of joint plates 20, the pivot piece 110, and the first clutch plate 40. The series of pins 120 also contact with the second clutch plate 50 and, when activated by exerting pressure on the head portion 130, cause the second clutch plate 50 to move away from the first clutch plate 40 as described in greater detail below. The head portion 130 may also include a post 140 and a closure cap 150. Each of the first and second clutch plates 40 and 50 include a post hole 190 through which the post 140 passes.

The head portion 130 may also include a housing 210 within which the series of pins 120 and the post 140 are positioned. In one embodiment, the series of pins 120 are activated by pressing or pushing the head portion 130 to force the series of pins 120 to extend down to exert force on the second clutch plate 50. In another embodiment, the closure cap 150 acts as a button which can be pushed to activate the series of pins 120 and force them to extend down to exert force on the second clutch plate 50. In yet another embodiment, activation mechanisms, such as push buttons, may be positioned on the pairs of joint plates 20 or 30 to activate and extend the series of pins 120.

Other embodiments for release mechanisms are also contemplated for use in the present invention. In one embodiment, any number of pins may be used to release the first and second clutch plates. In another embodiment, the joint plates 20 and 30 may include levers or switches which, when pressed or activated, cause the first and second clutch plates to separate. It is noted that any method of causing the release or separation of the first and second clutch plates is contemplated for use with the present invention.

Each joint plate in the first pair of joint plates 20 may be coupled together by the post 140 and the series of pins 120. Each joint plate in the second pair of joint plates 30 may also be coupled together by the post 140.

The pivot piece 110 provides a large, non-rotating diameter about which the pivot joint apparatus 10 can be adjusted. In one embodiment, the pivot piece 110 is a washer positioned adjacent to the central portion 90 of the first clutch plate 40. When the first and second clutch plates 40 and 50 are disengaged, the pivot joint apparatus 10 is adjustable by rotating joint plates in the first and second joint plates 20 and 30 about the pivot piece 110.

The pivot joint apparatus 10 may also include a spring mechanism 160. The second clutch plate 50 includes a first extension 170. One of the joint plates in the second pair of joint plates 30 includes a second extension 180 which is capable of insertion into the first extension 170. The spring mechanism 160 may be a coil wound around the first extension 170 and the second extension 180. The post 140 extends all the way through from the head portion 130 to the second pair of joint plates 30, as shown in FIG. 1.

FIG. 2 is a perspective view of a portion of the system of plates of the pivot joint apparatus 10. The first pair of joint plates 20 and the first clutch plate 40 are shown, with a portion of the first clutch plate 40 removed to show the pivot piece 110. The series of holes 100 through which the series of pins 120 pass extend through the first pair of joint plates 20, the pivot piece 110, and the first clutch plate 40.

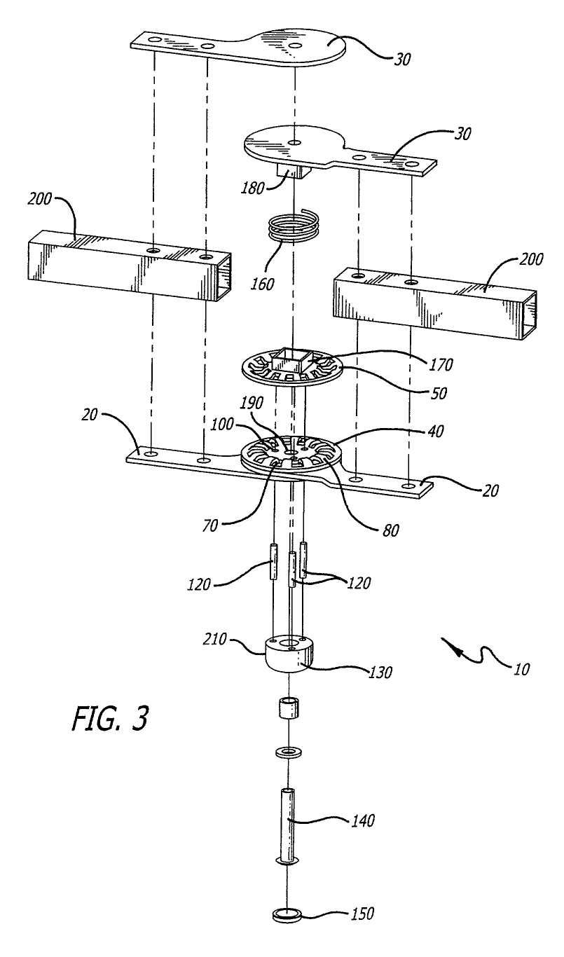

FIG. 3 is a perspective view of the pivot joint apparatus 10 according to the present invention, showing the various components in separated fashion. The pivot joint apparatus 10 may be used with any device or article of manufacture requiring an adjustable pivot joint. FIG. 3 shows members 200 which are securable to the pivot joint apparatus 10. The position of the members 200 can be adjusted by rotating at least one joint plate in each of the first and second pairs of joint plates 20 and 30 together about the pivot piece when the first and second clutch plates 40 and 50 are separated. One example of the use of a pivot joint apparatus 10 according to the present invention is in wheelchairs or strollers. Often, occupants of wheelchair or strollers must adjust the positioning of leg or arm rests or other components. This can be cumbersome for some occupants. Using the present invention, an occupant activates the release mechanism, adjusts the pivot joint apparatus and the component connected thereto to a desired position, and then deactivates the release mechanism. Additionally, the clutch plate locking feature adds strength and durability to the pivot joint component of the wheelchair or stroller. Accordingly, the members 200 are portions of a mechanical component to which the pivot joint apparatus is connected. The members 200 are provided to show a particular use for the pivot joint apparatus of the present invention. It is noted that although various aspects of the present invention are described in the context of wheelchair and strollers, those skilled in the art will appreciate that the pivot joint apparatus of the present invention is likewise suitable for use in various other mechanical environments. Accordingly, any reference to wheelchairs and strollers is intended only to illustrate the inventive aspects of the present invention, with the understanding that such inventive aspects have a wide range of applications.

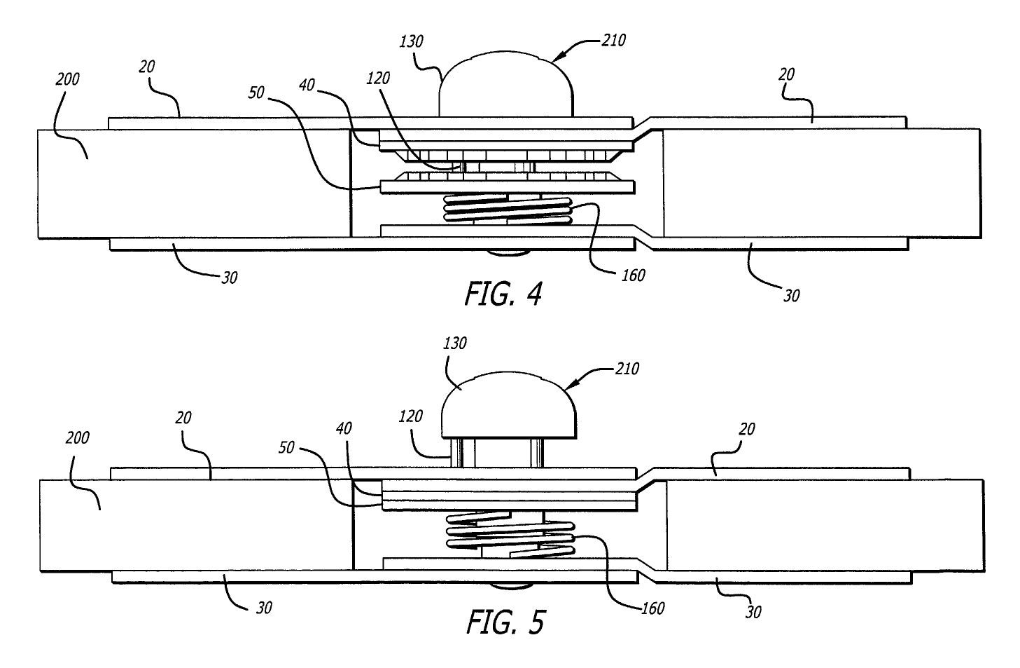

FIG. 4 is a side view of the pivot joint apparatus 10. The pivot joint apparatus 10 of FIG. 4 is in an unlocked position and ready for adjustment. To unlock, or disengage, the first and second clutch plates 40 and 50, the release mechanism is activated to force the series of pins 120 to extend and push the second clutch plate 50 away from the first clutch plate 40. This results in the bars 80 and the series of grooves 70 being disengaged from each other, allowing lateral movement of the first clutch plate 40 relative to the second clutch plate 50. Once the first and second clutch plates 40 and 50 have been disengaged, at least one of the joint plates in the first pair of joint plates 20 can be rotated, in conjunction with at least one joint plate from the second pair of joint plates 30, about the pivot piece 110.

When the series of pins 120 pushes the second clutch plate 50 away from the first clutch plate 40, the second clutch plate 50 pushes against the spring mechanism 160. When not pushed down by the second clutch plate 50 and the series of pins 120, the spring mechanism 160 also serves to bias the second clutch plate 50 against the first clutch plate 40 to provide further stability for the system of plates when the bars 80 and the series of grooves 70 of the first and second clutch plates 40 and 50 are engaged.

FIG. 5 is another side view of the pivot joint apparatus 10. The pivot joint apparatus 10 of FIG. 5 is in a locked position such that the plates making up the system of plates do not move. In FIG. 5, the first and second clutch plates 40 and 50 are engaged in a locked position, preventing the system of plates, and therefore the pivot joint apparatus itself, from moving. Additionally, the spring mechanism 160 biases the second clutch plate 50 against the first clutch plate 40.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A pivot joint comprising:
a plate system including a first pair of joint plates, a first clutch plate, a second pair of joint plates, and a second clutch plate, the first and second clutch plates each having a grooved portion such that the first and second clutch plates are interlockable by engaging the grooved portions in each of the first and second clutch plates;
a spring mechanism positioned between the second clutch plate and one joint plate in the second pair of joint plates; and
a pivot piece about which at least one joint plate in the first pair of joint plates and the first clutch plate are rotatable.

2. The pivot joint of claim 1, further comprising a series of pins positionable through the pivot piece.

3. The pivot joint of claim 2, wherein the pivot piece includes a series of holes through which the series of pins extend.

4. The pivot joint of claim 3, wherein the series of pins are positioned in and extend from a head portion through the first pair of joint plates, the pivot piece, and the first clutch plate.

5. The pivot joint of claim 4, wherein when activated, the series of pins disengage the grooved portions of the first and second clutch plates.

6. The pivot joint of claim 1, wherein one joint plate in the second pair of joint plates includes an extension capable of inserting into an additional extension of the second clutch plate, and the spring mechanism is coiled around the extension of the one joint plate in the second pair of joint plates and the additional extension in the second clutch plate.

7. The pivot joint of claim 1, wherein when the grooved portions of the first and second clutch plates are engaged with each other, the first clutch plate is prevented from rotating about the pivot piece.

8. The pivot joint of claim 7, wherein when activated from the head portion, the series of pins push the first and second clutch plates apart by pushing the second clutch plate against the spring mechanism to disengage the grooved portions of each of the first and second clutch plates, so that the first clutch plate and at least one joint plate in the first pair of joint plates are capable of rotating about the pivot piece and the series of pins to allow adjustment of the pivot joint.

9. The pivot joint of claim 4, wherein the head portion includes a closure cap, a post assembly and a housing, the post assembly passing through the head portion, the plate system, the pivot piece and the spring mechanism to secure the pivot joint together.

10. The pivot joint of claim 1, wherein the pivot piece provides a large, non-rotating diameter about which the pivot joint can be adjusted.

11. The pivot joint of claim 10, wherein the pivot piece is a washer positioned within at least one joint plate in the first pair of joint plates and adjacent to a central portion of the first clutch plate.

12. A pivot joint comprising:
a plate mechanism having a first clutch plate and a second clutch plate capable of lockably engaging, each of the first and second clutch plates having an elevated portion with a plurality of grooves and a plurality of bars therein such that when the elevated portions of each of the first and second clutch plates are aligned together, the plurality of bars of one of the first and second clutch plates lockably engage with the plurality of grooves of the other of the first and second clutch plate; and
a release mechanism having a series of pins configured to disengage the first clutch plate from the second clutch plate when the series of pins pushes the second clutch plate against a spring mechanism.

13. The pivot joint of claim 12, further comprising a first pair of joint plates.

14. The pivot joint of claim 13, further comprising a second pair of joint plates.

15. The pivot joint of claim 14, wherein one joint plate in the second pair of joint plates includes an extension capable of inserting into an additional extension of the second clutch.

16. The pivot joint of claim 14, wherein the series of pins are positioned in and extend from a head portion.

17. The pivot joint of claim 16, wherein the series of pins extend into a pivot piece having a series of holes, and when activated from the head portion, the series of pins push the first and second clutch plates apart by pushing second clutch plate against the spring mechanism to disengage the interlocking plurality of grooves and plurality of bars in the first and second clutch plates,

18. The pivot joint of claim 17, wherein after the first and second clutch plates are disengaged, the first clutch plate and at least one joint plate in the first pair of joint plates are capable of rotating about the pivot piece and the series of pins to allow a user to adjust the position of the pivot joint.

19. The pivot joint of claim 17, wherein after the first and second clutch plates are disengaged, the first clutch plate, at least one joint plate in the first pair of joint plates, and at least one joint plate in the second pair of joint plates are capable of rotating to allow a user to adjust the position of the pivot joint.

20. The pivot joint of claim 17, wherein the pivot piece provides a large, non-rotating diameter about which the pivot joint can be adjusted.

21. The pivot joint of claim 20, wherein the pivot piece is a washer positioned within at least one joint plate in the first pair of joint plates and adjacent to a central portion of the first clutch plate.

22. A method of pivoting a joint apparatus, comprising:
providing a plate system including a first pair of joint plates, a first clutch plate, a second pair of joint plates, and a second clutch plate, the first and second clutch plates each having grooved portions such that the first and second clutch plates are securable by interlocking the grooved portions in each of the first and second clutch plates;
releasing the first and second clutch plates by activating a series of pins to push the second clutch plate against a spring mechanism;
rotating at least one joint plate in the first pair of joint plates around a pivot piece; and
locking the first and second clutch plates in a desired position by deactivating the series of pins to release pressure on the spring mechanism and engage the grooved portions on the first and second clutch plates to prevent the first and second clutch plates from moving relative to each other.

23. The method of claim 22, wherein one joint plate in the second pair of joint plates includes an extension capable of inserting into an additional extension of the second clutch plate.

24. The method of claim 23, wherein the spring mechanism is coiled around the extension of the one joint plate in the second pair of joint plates and the additional extension of the second clutch plate.

25. The method of claim 22, wherein the series of pins extend into the pivot piece having a series of holes, and when activated from the head portion, the series of pins push the first and second clutch plates apart by pushing the second clutch plate against the spring mechanism to disengage the grooved portions in each of the first and second clutch plates,

26. The method of claim 25, wherein after the first and second clutch plates are disengaged, the first clutch plate and at least one joint plate in the first pair of joint plates are capable of rotating about the pivot piece and the series of pins to allow a user to adjust the position of the pivot joint.

27. The method of claim 25, wherein after the first and second clutch plates are disengaged, the first clutch plate, at least one joint plate in the first pair of joint plates, and at least one joint plate in the second pair of joint plates are capable of rotating to allow a user to adjust the position of the pivot joint.

28. The method of claim 22, further comprising providing a head portion for housing the series of pins.

29. The method of claim 25, wherein the pivot piece provides a large, non-rotating diameter about which the pivot joint can be adjusted.

30. The method of claim 29, wherein the pivot piece is a washer positioned within at least one joint plate in the first pair of joint plates and adjacent to a central portion of the first clutch plate.

31. A method of pivoting a joint apparatus, comprising:
providing a plate system including a pair of clutch plates each having grooved portions that allow the pair of clutch plates to interlock when interlocked together;
releasing the pair clutch plates by activating a release mechanism to force the pair of clutch plates apart;
rotating a first clutch plate in the pair of clutch plates about a pivot piece; and
locking the pair of clutch plates in a desired position by deactivating the release mechanism allowing the grooved portions on the pair of clutch plates to engage each other and prevent the pair of clutch plates from moving relative to each other.
